(19) United States
(12) Patent Application Publication
(10) Pub. No.: US 2026/0326691 A1
(43) Pub. Date: Oct. 22, 2026

(54) MODULAR ELECTRONIC FUSES AND FUSE BOX

(71) Applicant: FEP FAHRZEUGELEKTRIK PIRNA GMBH & CO. KG, Pirna (DE)

(72) Inventors: Olaf EICHLER, Dresden (DE); Frank SCHNEIDER, Dresden (DE)

(21) Appl. No.: 19/115,626

(22) PCT Filed: Sep. 27, 2023
(86) PCT No.: PCT/EP2023/076649

§ 371 Date: Mar. 26, 2025

(30) Foreign Application Priority Data
Sep. 27, 2022 (DE) 10 2022 124 801.1

(51) Int. Cl. B60R 16/023; H01H 85/143; H01H 85/20; H01H 85/30

(52) U.S. Cl. CPC B60R 16/0239; B60R 16/0238; H01H 85/143; H01H 85/2005; H01H 85/2015; H01H 85/30; H01H 2085/208

(57) ABSTRACT

An architecture of a set consisting of a number n of electronic fuses (S1, S2, S3, . . . , Sn) is provided for controlled separation and connection of one or more electronic circuits iₖ or channels having one of the fuses (S1, S2, S3, . . . , Sn). Each fuse (S1, S2, S3, . . . , Sn) has a fuse housing and a connection base having connection contacts (E, A), wherein these have an input contact (E) and output contacts (A1, A2, A3, . . . , AK) for each circuit iₖ or channel k to be switched. The output contacts have, in terms of circuitry, at least one carrier structure/printed circuit board integrated in each fuse (S1, S2, S3, . . . , Sn) and equipped with electronic switching elements and are each connected, in terms of circuitry, to the input contact (E).

The invention relates to a flexibly adaptable architecture of a modular solution of electronic fuses (eFuse) for fuse-protecting electronic circuits, preferably in a vehicle on-board network, as well as a fuse box which is modularly equippable with such electronic fuses. In addition to vehicle applications and on-board networks, the invention also relates to other electronic applications where a variable quantity of circuits is to be fuse-protected in each case.

In the art, various fuses are already known to separate circuits. Safety fuses are still traditionally used, however, they involve many disadvantages and are each adjusted to a specific and fixed disconnect condition, for instance a maximum permissible current. Upon exceeding the permissible amperage, the fusible wire is melted, and the fuse is no longer functional thereafter.

Especially in motor vehicles, electrical loads are typically arranged in an on-board network. The loads are divided into safety-relevant loads and not safety-relevant loads, such as, e.g., QM (quality management) loads. During operation of the on-board network, it is important that the energy supply for the safety-relevant loads, in particular, is ensured and guaranteed at all times. To guarantee the safety of the on-board network, it is known to monitor the energy supply in the on-board network and thus in the motor vehicle. There is a fundamental need to meet functional safety requirements anyway (ISO26262).

FIG. 1 of DE 102020213357 A1 shows a possible topology of an energy supply system consisting of a basic on-board network which comprises an energy storage with an associated battery sensor as well as several loads which are fuse-protected or driven by an electronic load distributor. The electronic load distributor comprises several switching means, each driving or fuse-protecting safety-relevant loads, in particular. For example, the semiconductor switches act, as per certain criteria such as (overvoltage, (over)current, temperature, etc., as an electronic fuse to separate the respective fuse-protected load from the energy supply during inadmissible operating conditions. Connected to a further

switching means of the electronic load distributor is, as an example, a further load distributor via which further loads are fuse-protected (for example via safety fuses) and supplied with energy in a targeted manner. These loads can, for example, be lights, windshield wipers, or such loads as are employed, for example, subsequently to a vehicle crash. Furthermore, the electronic load distributor comprises a separator to separate the electronic load distributor from the on-board subnetwork.

However, the load distributor and the switching means possess a fixed topology tailored to the on-board network, and this topology is not transferable to other on-board networks in a flexible manner. Hence, for a quantity of different vehicles, even of the same series by a manufacturer, a large quantity of load distributors and fuse boxes are needed to be tailored to the respective vehicle configuration. This is disadvantageous and expensive.

Circuitry for controlling different electrical loads in a motor vehicle is known from DE 4329860 A1. The solution relates to a circuitry arrangement for controlling different electrical loads in a motor vehicle. The circuitry arrangement is connected to a voltage source and to input switches on the input side, and to the loads to be controlled on the output side. Each load has an assigned individual semiconductor element which, upon a short circuit occurring at the semiconductor element output, cuts off the assigned load from the voltage source and which, upon the short circuit ending, reconnects the assigned load to the voltage source. Even for loads which convert relatively high electrical power in the motor vehicle, such as, for example, a passenger compartment heater, a semiconductor element is provided for driving. In particular, MOSFET transistors are used as semiconductor components.

Here too, the switching elements and fuse devices are fixedly installed in the circuitry so that variable adaptation to different on-board networks or requirements is not readily possible.

The printed publications DE 102005013440 A, JP 2007288356, and EP 1870978 A show further alternative, but likewise inflexible, solutions which are each statically tailored to a specific case of application.

In addition to the fundamental need for greater variability and flexibility, a further need is to be able to adapt or modify a fuse box or fuse architecture, in particular even after installation in an application or a vehicle on-board network. In addition, it would be desirable to be able to enable and disable certain loads and devices without any specific disconnect condition occurring during use.

Hence, it is known that in vehicle configuration, high expenditure is involved if the customer requires specific components in the vehicle which are provided as accessories or optional equipment. On the one hand, the configuration cannot be changed later, and on the other hand, there are devices that might be desirable to be enabled depending on the user behaviour during operation, for instance, by paying a fee.

With the solutions known in the art, such flexible, variable solutions, which are still adaptable during operation, cannot be realised in the desired manner.

It is therefore an object of the present invention to overcome the disadvantages present in the art and in particular to propose a cost-effective, case-by-case adaptable and flexible solution which makes a number of applications, in particular fuse concepts, realisable in a vehicle on-board network.

According to the invention, a set is proposed consisting of a number n of electronic fuses (S1, S2, S3, . . . , Sn) for controlled separation and connection of one or more electronic circuits or channels having one of the fuses, wherein each fuse has a fuse housing and a connection base having connection contacts. According to the invention, these have exactly one or at least one input contact and correspondingly k output contacts for each circuit or channel to be switched, which output contacts have, in terms of circuitry, at least one printed circuit board integrated in each fuse and equipped with electrical switching elements (or a carrier structure having conductive elements/traces) and are each connected, in terms of circuitry, to the input contact, wherein the following conditions apply:
n∈ [symbol] where n≥4, and
k∈ [symbol] where k=1, 2, 3 to n.

The number of n electronic fuses is advantageously in an order of magnitude of 10 to 50, in any case greater than/equal to 4, since the modularity can then be achieved in a particularly efficient manner. Whilst modular concepts are known in the art, in accordance with the present idea, a significantly larger quantity of solutions can be realised using a building-block principle due to the combinatorics of modularity at fuse level (modular electronic fuse with several channels) on the one hand and, in a complementary manner, modularity at variant level (fuses of different designs) on the other hand, with a substantially smaller quantity of variants provided. Here, the multi-channel variants themselves are already employable in a particularly versatile manner since these solutions allow not only modularity in a first (higher-order) hierarchy but also modularity in a lower-order hierarchy (at fuse level).

The concept of the present invention thus consists in optimising and realising the following components:
modular construction of electronic fuses (1-way/2-way/4-way/ . . . /multi-way channels),
building-block system consisting of the modular fuses and the variants,
possibility of combining different power classes of the known classes of plug-in fuses of typically 1 to 80A or screw fuses of typically 80 to 400A,
at the same time, the possibility of a flexible, adaptive, and modular construction of electronic fuse boxes (ePDU/eHSB) with the combination of individual plug-in modules, variants, and the combination of further electrical modules on a common printed circuit board.

In a further advantageous design of the invention, it is provided that the connection contacts are formed as plug contacts, solder contacts, or press-fit contacts with a common mounting direction or extension direction. In this way, boxes that are especially easy to mount and neat can be realised in which all fuses are fixable in a mounting plane and are mountable, e.g., by plugging them into plug contacts.

A further optional development of the invention provides that the connection contacts are formed with an opening provided for screw-fixing to connect these electrically to a circuit by means of a screwable connecting means. Conceivable are, for instance, power rails or bus bar connections with a screw solution.

It is further advantageous if the connection contacts provided for screw-fixing are arranged or protrude on opposite sides of the electrical fuses.

It is further advantageous if the, or all, switching elements of the electronic fuses (S1, S2, S3, . . . , Sn) are individually adjustable regarding their separation and switching conditions, in particular programmable or adaptable via an integrated communication interface.

A yet further aspect of the present invention relates to the design of the connections. It is advantageously provided that the input contact has a current carrying capability which corresponds to the sum of the current carrying capabilities of the plug contacts or is at least 60-80% of the sum thereof. In this way, e.g., a channel can be switched off (load shedding) and the current flowing via the input contact can be distributed across the remaining channels or can only be directed via a safety-relevant circuit, i.e., one channel (if the current demand is temporarily higher there). This function may become required, for instance, if a circuit is to be supplied safely for the purpose of on-board network stability, but no current needs to flow in a different circuit which is fuse-protected by the same fuse. This dynamic adaptability constitutes a particular advantage over conventional solutions.

One possible realisation provides that the input contact is geometrically designed in cross-section to be equal to or greater than the sum of the respective cross-sections of the plug contacts which are defined as outputs.

It is further advantageous if the, or all, switching elements of the respective electronic fuses are individually activatable or deactivatable even in the installed state during operation as intended, irrespective of whether a specific separation or switching condition has occurred in the on-board network.

Also beneficial is a solution where the separation or switching condition of one, several, or all electronic switching elements constitutes either a current threshold or a voltage threshold, wherein in particular a disconnect condition is provided to ensure that the on-board network voltage remains stable and, in the event of an excessively high voltage drop in a circuit or load circuit, the relevant switching element is switched to its separated position.

A further aspect of the present invention relates to a fuse box formed or having a number of interfaces, in particular connection bases formed for connecting to a selection of electronic fuses selected or selectable from the set of electronic fuses as described previously.

It is further advantageous if the fuse box is formed to accommodate a mixed equipment with electronic fuses as well as further, different conventional fuse types, such as safety fuses.

Other advantageous developments of the invention are characterised in the dependent claims and/or illustrated in greater detail below together with the description of the preferred embodiment of the invention with reference to the figures.

### IN THE DRAWINGS

FIG. 1 shows an electronic fuse formed as a plug-in module 20-40A, 1-way (i.e., for one fuse protection channel or circuit);

FIG. 2 shows an electronic fuse formed as a plug-in module 20-40A, 4-way (i.e., for 4 fuse protection channels or circuits);

FIG. 3 shows an electronic fuse formed as a plug-in module 1-20A, 4-way (i.e., for 4 fuse protection channels or circuits);

FIG. 4 shows an electronic fuse formed as a screw-in module 40-400A, 6-way (i.e., for 6 fuse protection channels or circuits); and

FIG. 5 shows a hybrid fuse box with a selection from the set Sn of fuses according to the invention.

The figures are schematic examples. In the following, the invention is described in more detail with reference to the figures, wherein the same reference numerals in the figures indicate the same functional and/or structural features.

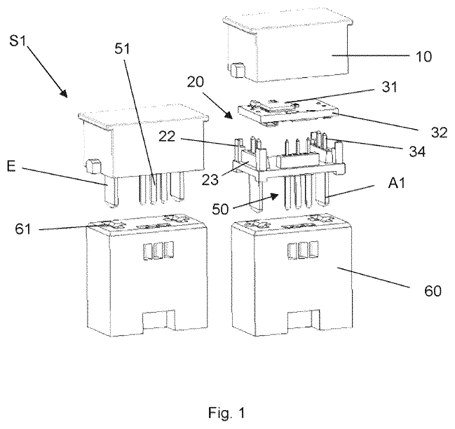

FIG. 1 shows an electronic fuse S1 formed as a plug-in module for 20-40A, 1-way, i.e., for fuse-protecting one circuit or channel extending from the input E via a switching element 31 on the printed circuit board 30 to the output A1. This example fuse S1, selected from the set 100 consisting of a number n of electronic fuses S1, S2, S3, . . . , Sn for controlled separation and connection of one or more electronic circuits iₖ or channels, further possesses a fuse housing 10 and a connection base 20 (plug base) having the two connection contacts E, A1. Further, the fuse S1 has a communication interface 50 with several signal contacts 51 for data transmission and communication with the fuse S1.

For this purpose, the fuse S1 has corresponding electronic components 33 arranged on the printed circuit board 32. As is further discernible from FIG. 1, the contacts E, A1, 51 each possess a plug-side contact end 34 which is pluggable into a corresponding contact socket 61 at a mating plug base 60. At the opposite end of the respective contacts E, A1, 51, there are contact ends 34 on the printed circuit board side for making contact with the printed circuit board 32. Further, corner-side supporting and holding means 22 for supporting and laterally holding the printed circuit board 32 are provided at the connection base 20. Further, contact bearing blocks 22 are provided on the side facing the printed circuit board 32, through which the respective contact ends 34 on the printed circuit board side project or protrude.

As can also be clearly discerned in FIG. 1, the contact geometry on the plug-in side of the contacts E, A1, 51 is formed differently, and the flat contacts E, A1 form pin contact sections, preferably pin contact sections with a round or square cross-section. In this respect, a fuse with an optimised contact design is also proposed.

By means of the concept, the printed circuit board can be equipped with the corner-side bearing blocks 22 on both sides. At the upper end of the corner-side bearing blocks 22, there are L-shaped corner bracket sections as a stop for the printed circuit board 32.

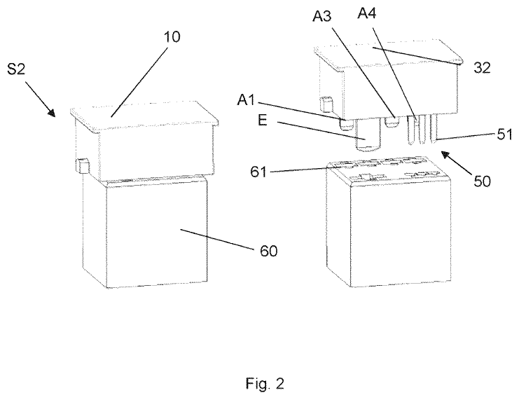

In FIG. 2, an electronic fuse S2 is formed as a plug-in module for 1-20A, 4-way, i.e., for fuse-protecting four circuits. One of the contacts constitutes the input contact E. Further, four output contacts A1, A2, A3, A4 are provided which are provided for each circuit iₖ (i₁, i₂, i₃, i₄) or channel k to be switched and are connected, in terms of circuitry, via at least one printed circuit board 32 integrated in the fuse S2 and equipped with electronic switching elements 31, to the input contact E. Otherwise, the topology of the fuse S2 is similar to the topology of the fuse S1 of FIG. 1.

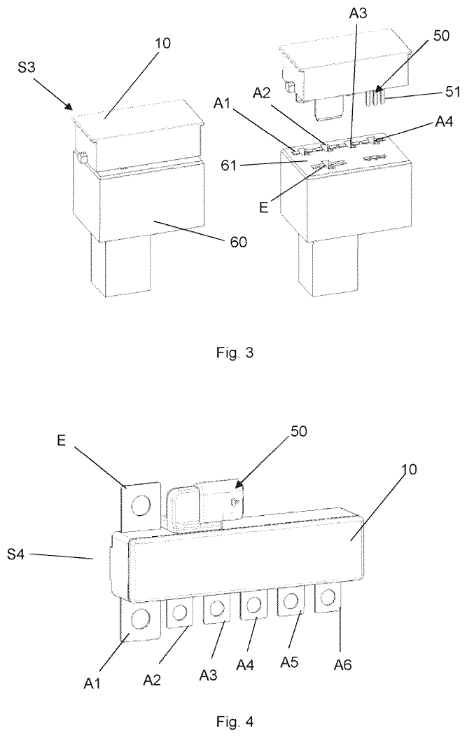

FIG. 3 shows a fuse similar to FIG. 2 which is, however, configured for other amperages. Otherwise, the reference numerals indicate the features already explained.

FIG. 4 shows an alternative solution of an electronic fuse S4, the fuse concept of which (thus construction in the interior of the fuse housing 10) is con-ceptually constructed analogously to the fuses S1 to S3. The connection base(s) 20 are each distributed on both sides on the two opposite longitudi-nal sides and are provided with the connection contacts E, A1-A6, wherein the connection contacts E, A1-A6 are formed as screw solutions and therefore form an opening 22 which serves as a screw-fix connection. It is also discernible that the connection cross-section of the output contacts A1 and A2 to A6 is formed differently. The total current, which is distributed across all output contacts A1 to A6 via the input contact E, can also be carried, e.g., only via the output contact A1, which has been configured to be sufficiently large for this purpose (analogously to the input contact E). Further, the fuse S4 has a communication interface 50 with several signal contacts (not shown) for data transmission and communication of the fuse S1 with an ex-ternal apparatus, for instance a control apparatus.

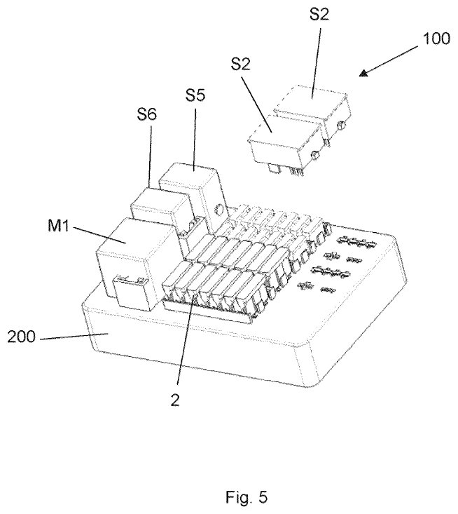

FIG. 5 shows a hybrid fuse box 200 which has been configured to equip it, on the one hand, with a quantity of electronic fuses S2, S5, S6 (from the set 100). In a complementary manner (but not necessarily), conventional plug bases for safety fuses 2 can also be provided. Further, an electronic module M1 is optionally formed to be pluggable and plugged into a corresponding plug base.

The fuse box 200 according to the invention can also be formed as a non-hybrid solution. Further, the invention can be used analogously with distribution boxes or load distributors, EM boxes, preliminary fuse boxes, or main fuse boxes, so that the term fuse box in the sense of the invention is generally understood to mean a fuse box in which a quantity of different electronic fuses Sn are used.

The invention is not limited in its execution to the above-mentioned preferred exemplary embodiments. Rather, a quantity of variants are conceivable which make use of the illustrated solution even in the form of fundamentally different embodiments. Hence, according to the concept of the invention, the set 100 is not limited to the illustrated variants, but can comprise a number of further electronic fuses Sn, each relating to a different quantity of channels, connection bases, sizes, and/or geometries, etc. It is essential that all the electronic fuses have the basic functions of the described electronic fuses, possess at least one connection base and a housing, and the conceptual construction in the housing is formed as described previously.

1. A set (100) consisting of a number n of electronic fuses (S1, S2, S3, . . . , Sn) for controlled separation and connection of one or more electronic circuits iₖ or channels having one of the fuses (S1, S2, S3, . . . , Sn), wherein each fuse (S1, S2, S3, . . . , Sn) has a fuse housing (10) and a connection base (20) having connection contacts (E, A), wherein these have an input contact (E) and output contacts (A1, A2, A3, . . . , AK) for each circuit iₖ or channel k to be switched, which output contacts have, in terms of circuitry, at least one carrier structure (32) having electrical conductors or traces integrated in each fuse (S1, S2, S3, . . . , Sn) and equipped with electronic switching elements (31) and are each connected, in terms of circuitry, to the input contact (E), and wherein
n∈ [symbol] where n≥4, and
k∈ [symbol] where k=1, 2, 3 to n.

2. The set (100) according to claim 1, characterised in that the connection contacts (E, A) are formed as plug contacts, solder contacts, or press-fit contacts with a common mounting direction or extension direction.

3. The set (100) according to claim 1, characterised in that the connection contacts (E, A) are formed as screw-in contacts with an opening (22) provided for screw-fixing to connect these electrically to a circuit iₖ by means of a screwable connecting means.

4. The set (100) according to claim 3, characterised in that the connection contacts (E, A) provided for screw-fixing are arranged or protrude on opposite sides of the electronic fuses (S1, S2, S3, . . . , Sn).

5. The set (100) according to claim 1, characterised in that the input contact (E) has a current carrying capability which corresponds to the sum of the current carrying capabilities of the output contacts (A1, A2, A3, . . . , AK) or is at least 60-80% thereof.

6. The set (100) according to claim 1, characterised in that the input contact (E) is geometrically designed in cross-section to be equal to or greater than the sum of the respective cross-sections of the output contacts (A1, A2, A3, . . . , AK).

7. The set (100) according to claim 1, characterised in that several, or all, electronic fuses (S1, S2, S3, . . . , Sn) further have a communication interface (50) possessing a quantity of signal contacts (51) in the region of the plug base or connection base.

8. The set (100) according to claim 1, characterised in that the, or all, switching elements (31) of the electronic fuses (S1, S2, S3, . . . , Sn) are individually adjustable regarding their separation and switching conditions, in particular programmable or adaptable via an integrated communication interface (50).

9. The set (100) according to claim 8, characterised in that the, or all, switching elements (31) of the respective electronic fuses (S1, S2, S3, . . . , Sn) are individually activatable or deactivatable or alterable even in the installed state during operation as intended, irrespective of whether a specific separation or switching condition has occurred in the on-board network.

10. The set (100) according to claim 1, characterised in that the separation or switching condition of one, several, or all electronic switching elements constitutes either a current threshold or a voltage threshold, wherein in particular a disconnect condition is provided such that the on-board network voltage remains stable and, in the event of an excessively high voltage drop in a circuit or load circuit, the relevant switching element (31) is switched to its separated position.

11. The set (100) according to claim 1, characterised in that the set comprises at least one, preferably several, of the electronic fuses (S1, S2, S3, . . . , Sn) as multi-channel fuses with a corresponding quantity of output contacts (A1, A2, A3, . . . , AK).

12. A fuse box (200) having a number of interfaces, in particular connection bases formed for connecting to a selection of electronic fuses (S1, S2, S3, . . . , Sn) selected from the set (100) of n electronic fuses (S1, S2, S3, . . . , Sn) according to claim 1.

13. The fuse box (200) according to claim 12, characterised in that the fuse box (200) is formed to accommodate a mixed equipment with electronic fuses (S1, S2, S3, . . . , Sn) according to claims 1 to 11 as well as further, different fuse types, such as safety fuses 2 and non-electronic fuses.

14. The fuse box (200) according to claim 13, characterised in that the fuse box (200) is further formed with plug bases having contacts to plug pluggable electronic modules (M1) and electronic assemblies therein with their mating contacts.
